(19) United States
(12) Patent Application Publication
(10) Pub. No.: US 2012/0073453 A1
(43) Pub. Date: Mar. 29, 2012

(54) MOBILE MEAT ROASTER

(76) Inventor: Kwang-Ho Choi, Seoul (KR)

(21) Appl. No.: 13/248,088

(22) Filed: Sep. 29, 2011

Related U.S. Application Data
(63) Continuation of application No. PCT/KR2010/001945, filed on Mar. 30, 2010.

(30) Foreign Application Priority Data
Mar. 30, 2009 (KR) 10-2009-0027053

(51) Int. Cl. A47J 37/04

(52) U.S. Cl. 99/443 R

(57) ABSTRACT

The present invention relates to a mobile meat roaster, which includes: a casing which forms the outer body; a heat supply part mounted in the casing far providing heat to food; and a first grill operation unit mounted at the upper portion of the heat supply part for rotating the grill as well as moving it in the vertical and horizontal directions, wherein the first grill operation part includes a first grill fixing part for attaching or detaching an end of grill, horizontal moving unit for moving the grill in horizontal direction, a rotating unit for rotating the grill, and a lifting unit for moving the grill in the vertical direction.

### CROSS REFERENCE TO RELATED APPLICATIONS

This application is a continuation of International Patent Application No. PCT/KR2010/001945, filed Mar. 30, 2010, entitled “Mobile Meat Roaster”, which claims priority of Korean Patent Application No. 10-2009-0027053, filed Mar. 30, 2009, the entire disclosures of which are hereby incorporated by reference in their entirety.

### BACKGROUND OF THE INVENTION

The present invention relates to a mobile meat roaster, and more specifically to a mobile meat roaster wherein the grill used for roasting is moved in the horizontal direction, rotated and moved upward and downward so that no part of the grilled food is burned but instead cooked uniformly and overall convenience is improved.

### DESCRIPTION OF THE RELATED ART

When roasting meat, etc. outdoors, it is important that the meat, etc. is not burned but cooked uniformly overall.

In using conventional outdoor cooking and roasting tools, the user should turn over meat, etc. one by one to prevent them from burning. But the problem is that since the user should not only roast the meat but also cook other foods or do other work at the same time, it is not easy to turn over the meat, etc. in time.

Another problem is that if the user concentrates his mind on turning over meat, etc., it is not easy for him to carry out another work and something may burn.

Another problem is that the worker's roasting work is difficult due to smoke and smell at the time of roasting work.

Yet another problem is that a table, cooking shelf and cooking tools should be prepared separately when the conventional meat roaster is used outdoors.

### SUMMARY OF THE INVENTION

Accordingly, to solve the above problems, it is an object of the present invention to provide a mobile meat roaster whereby user's work convenience outdoors is improved and the taste of the roasted meat is improved.

In order to accomplish the foregoing objects, according to an embodiment of the present invention, there is provided a mobile meat roaster comprising: a casing which forms the main body of the meat roaster; a heat supply part arranged in the casing for providing heat to the food to be grilled; and a first grill operation unit mounted at the upper portion of the heat supply part for rotating a grill as well as moving it in a vertical direction and a horizontal direction during cooking, wherein the first grill operation unit includes a grill fixing part to which one end portion of the grill is detachably connected, a horizontal moving unit for moving the grill in the horizontal direction, a rotating unit for rotating the grill, and a lifting unit for moving the grill in the vertical direction.

In the present invention, the horizontal moving unit may include: a main body including a first guide rail; a feed screw which is mounted on the main body and is operatively connected to a first driving motor at one end; and a linear moving part which is mounted on the feed screw, and one side of which is slidably installed on the first guide rail, wherein the grill fixing part is coupled to the linear moving part.

The rotating unit may include: a first rotating axis and a second rotating axis which are installed on a fixed frame mounted on the main body of the horizontal moving unit with a predetermined distance; a first sprocket installed on one end portion of the first rotating axis; a first rotary gear installed on the other end portion of the first rotating axis to transmit driving force; a second sprocket installed on one end portion of the second rotating axis; a second rotary gear installed on the other end portion of the second rotating axis to transmit driving force; a chain which operatively connects the first sprocket and the second sprocket to transmit driving force therebetween; and a second driving motor which is connected to the first rotating axis or the second rotating axis to provide driving force thereto, and the grill fixing part may include: a spindle mounted at the upper portion of the linear moving part to fix the grill, and a spindle gear installed on one end portion of the spindle to be selectively engaged with the first rotary gear or second rotary gear according to the movement of the linear moving part.

The lifting unit may include: a guide board which has second guide rails and a rack gear, and is vertically mounted to the main body of the meat roaster; lifting sliders which are slid up and down along the second guide rails, and have a pinion gear meshed with the rack gear of the guide board, and are coupled to the main body of the horizontal moving unit; and a third driving motor which is connected to the pinion gear to provide driving force thereto.

The heat supply part may include: a heat supply housing positioned in the casing; a heat exchange jacket arranged around the heat supply housing to absorb circumferential heat; a gas burner mounted on the floor of the heat supply housing for providing heat; and a charcoal storage housing detachably mounted in the heat supply housing to store charcoal.

The casing may further include a ceramic burner for providing heat from above to below.

The casing may further include a cover arranged at the upper portion thereof.

The casing may further include a movement means rotatably installed at the bottom portion thereof.

The casing may further include a table shelf pivotally connected to one side thereof so as to be folded and unfolded manually.

The casing may further include a cooking shelf pivotally connected to one side thereof so as to be folded and unfolded manually.

The grill may be any one of a single grill, a double grill, a convex grill or an automatic opening type grill.

The single grill or convex grill may have one end portion fixed to the spindle and the sectional shape of the one end portion is rectangular.

The double grill may include a fixed member which has one end portion fixed as one to the spindle, grill couplers installed at both end portions of the fixed member to fix the double grill, and an elastic means installed between the grill fixing part and the grill coupler to provide elastic force thereto.

The automatic opening type grill may include: a first grill and a second grill which are pivotally connected at one side to each other by hinges so as to be folded; a grill-pinion gear which is installed at the coupled side of the second grill to transmit rotary force thereto; a grill-rack gear which is attached to the coupled side of the first grill to mesh with the grill-pinion gear for rotating the second grill by moving in a longitudinal direction; a actuating cylinder which is attached on one side of the first grill to move the grill-rack gear in the longitudinal direction; an engaging member fixed on one side of the second grill; a hook rotatably installed on one side of the first grill to be detachably connected to the engaging member, wherein the hook has a rotary spring to add rotary force in one direction; a hook release pin installed on one end portion of the grill-rack gear to separate the engaging member as the grill-rack gear is moved in the longitudinal direction; and a rotary shaft, one end portion of which is fixed to the first grill and the other end portion of which is fixed as one to the spindle.

The casing may further include a storage box attached at one side thereof to store cooking tools.

The casing may further include a gas burner positioned adjacent to a second grill operation unit at one side thereof.

The casing may further include a gas range and a controller for controlling the operation of the gas range and the second grill operation unit.

According to another embodiment of the present invention, there is provided a mobile meat roaster comprising: a casing which forms the main body of the meat roaster; a heat supply part arranged in the casing for providing heat to the food to be grilled; a convex grill in which the food to be grilled is contained, wherein the food to be grilled is grilled above the heat supply part; a grill operator mounted at the upper portion of the heat supply part for rotating a grill as well as moving it in a vertical direction during cooking, wherein one end portion of the convex grill is connected to the grill operator; a second grill fixing part mounted at the other side of the grill operator, and to which the other end portion of the convex grill is detachably connected, and wherein the grill operator includes: a rotating part for rotating the grill operator to left and right; and a lifting part having a first frame which is fixed on the rotating part and has a second feed screw rotated by a motor and first guide bars fixed across both end portions of the first frame, and a slider through which the second feed screw and the first guide bars are installed to be lifted and lowered by the rotation of the second feed screw, and to which one end portion of the convex grill is rotatably connected, and wherein the second grill fixing part includes: a second rotating plate rotatably mounted on the heat supply part; a second frame which is fixed on the second rotating plate and has second guide bars; and a second slider through which the second guide bars are installed to be lifted or lowered along the second guide bars, and to which the other end portion of the convex grill is detachably connected.

According to the above mentioned mobile meat roaster of the present invention, it has the effects as follows. It is possible to accurately check the roasting condition of the grilled food by moving the grill forward, prevent the user from inhaling gases and burning from flames, and improve user's work convenience.

Also, since heat is uniformly distributed to the whole of the grilled food by rotating the grill, it is possible to prevent the grilled food from burning and improve the taste of the grilled food.

Also, since roasting work can be done about four times faster than the conventional device, roasting time is shortened and a large quantity of meat can be roasted continuously.

Also, since the grill is rotated continuously while cooking temperature is maintained uniformly at all times, the meat can be roasted uniformly without being partially burned or undercooked.

Also, since the food can be turned over just like being turned over by hand, the food can be cooked tastier, so uniform taste can be achieved regardless of the personal skills of a cook and seasoning the meat becomes convenient for the cook.

Also, whereas it is difficult to control the power of charcoal fire when using charcoal as a heat source, it is possible to control the food roasting temperature by adjusting the grill upward or downward because the grill is moved along the vertically direction in the present invention.

Also, a ceramic burner is placed in the upper portion of the casing to help gas burn completely and heat is provided from top to bottom, so the food can be cooked without turning it over.

Also, by using a cover, it is possible to prevent rainwater from flowing into the casing in rainy days and prevent various impurities from staining it during storage. It is also possible to prevent the grill, etc. from being damaged during transit.

Also, since mobile meat roaster is provided with a table shelf, it is convenient to take a meal outdoors without preparing a separate table, so overall convenience is improved.

Also, since mobile meat roaster is provided with a cooking shelf and a storage box, it improves user's work convenience during cooking.

Also, since the recovered heat of the heat exchanger jacket is used for heating and hot water, the waste heat is minimized and the waste of energy is minimized, so that it is possible to gain an enhanced energy saving effect at a national level as well.

### BRIEF DESCRIPTION OF THE DRAWINGS

The above objects, features and advantages of the present invention will become more apparent to those skilled in the related art in conjunction with the accompanying drawings. In the drawings:

FIG. 1 is a schematic perspective view of a mobile meat roaster according to a first embodiment of the present invention;

FIG. 2 is a schematic front sectional view of FIG. 1;

FIG. 3 is a schematic exploded perspective view of a first grill operation unit;

FIG. 4 is a perspective view illustrating how a double grill is mounted on the first grill operation unit of FIG. 3;

FIG. 5 is a perspective view illustrating how the first grill operation unit of FIG. 4 is rotated;

FIG. 6 is a schematic sectional view illustrating how the grill is detachably connected to a linear moving part;

FIG. 7 is a schematic sectional view illustrating how the double grill is coupled to the linear moving part;

FIG. 8 is a perspective view illustrating how the double grill is coupled to a grill coupler;

FIG. 9 is a perspective view illustrating the shape of an automatic opening type grill;

FIG. 10 is a perspective view illustrating how a table shelf operates;

FIG. 11 is a perspective view of how the cooking shelf operates;

FIG. 12 is a perspective view illustrating how a convex grill is mounted on the device shown in FIG. 1;

FIG. 13 is a schematic front sectional view of FIG. 12;

FIG. 14 is a perspective view of a mobile meat roaster equipped with the gas burner of a second embodiment of the present invention;

FIG. 15 is a perspective view illustrating how a convex grill is mounted in FIG. 14;

FIG. 16 is a schematic perspective view of a mobile meat roaster according to a third embodiment of the present invention;

FIG. 17 is a block diagram illustrating the grill operator and grill fixing part of FIG. 16; and

FIG. 18 is a perspective view illustrating how the device shown in FIG. 16 operates.

### DESCRIPTION OF REFERENCE NUMERALS IN DRAWINGS

1: Cover,
2: Heat supply part
3: Storage layer,
4: Table shelf
5: Cooking shelf,
30: Grill fixing part
40: First grill operation unit,
41: Table self-rack gear
51: Cooking shelf-rack gear,
201: Heat supply housing
202: Charcoal storage housing,
203: Heat exchange jacket
204: Water inlet,
205: Water outlet
206: Gas burner,
301: Spindle
302: Spindle gear,
303: Bearing
411: First guide rail,
412: Main body
413: Feed screw,
414: First driving motor
415: Linear moving part,
421: First rotating axis
422: Second rotating axis,
423: First sprocket
424: Second sprocket,
425: First rotating gear
426: Second rotating gear,
427: Chain
428: Second driving motor,
429: Fixed frame
431: Guide board,
432: Rack gear
433: Second guide rail,
434: Pinion gear
435: Lifting slider,
436: Third driving motor
501: Single grill,
502: Fixed member
503: Grill coupler,
504: Double grill
505: Convex grill,
506: Elastic spring
510: Automatic opening type grill,
511: First grill
512: Second grill,
513: Hinge
514: Grill-pinion gear,
515: Grill-rack gear
516: Actuating cylinder,
517: Engaging member
518: Hook,
519: Hook release pin
520: Rotary shaft,
601: Ceramic burner
602: Control link,
603: Radiation plate
701: Wheel,
1000: Mobile meat roaster
2000: Mobile meat roaster,
2006: Storage box
2081: Gas range,
2082: Sliding door cover
2090: Controller,
2100: Cover
2400: Second grill operation unit,
2600: Gas burner
3000: Mobile meat roaster,
3100: Grill operator
3110: First rotating plate,
3120: First frame
3150: Slider,
3200: Second grill fixing part
3210: Second rotating plate,
3220: Second frame
3230: Second guide bar,
3240: Second slider
3300: Convex grill,
3310: Driving motor
3400: Table shelf

### DETAILED DESCRIPTION OF THE INVENTION

Hereinafter, preferred embodiments of the present invention will be provided to allow those skilled in the art to which the present invention pertains to more clearly understand and easily embody the present invention with reference to the accompanying drawings. However, a variety of modifications, variations and/or alterations of such embodiments of the present invention may be possible and the present invention is not particularly restricted to the following embodiments. For clarity, some components or parts irrelevant to technical configurations of the present invention will be omitted from the drawings, and like reference numerals denote elements having substantially the same configurations or performing similar functions and actions throughout the drawings.

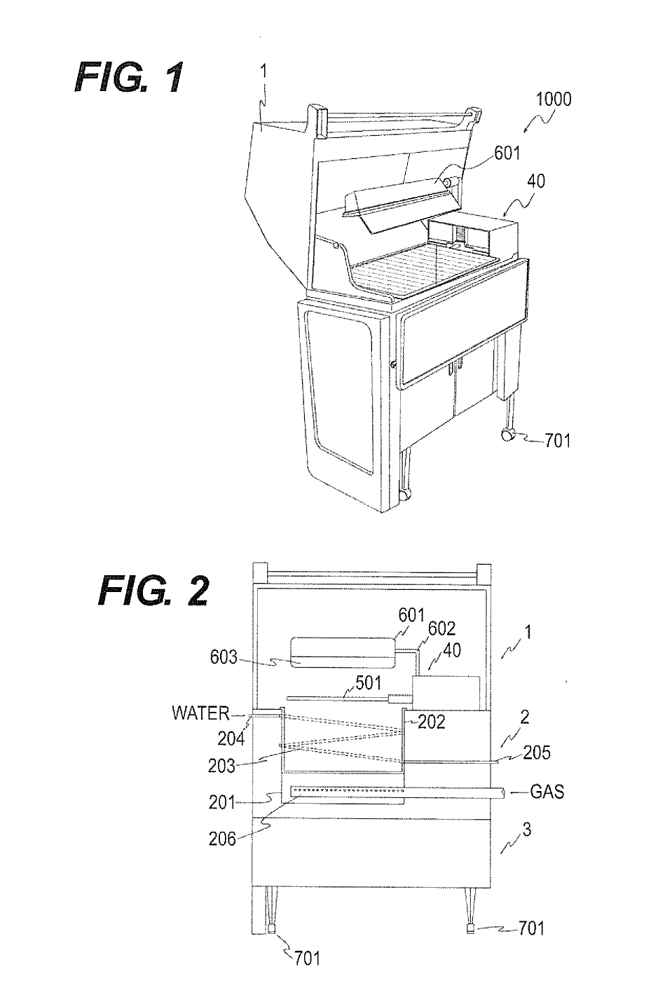

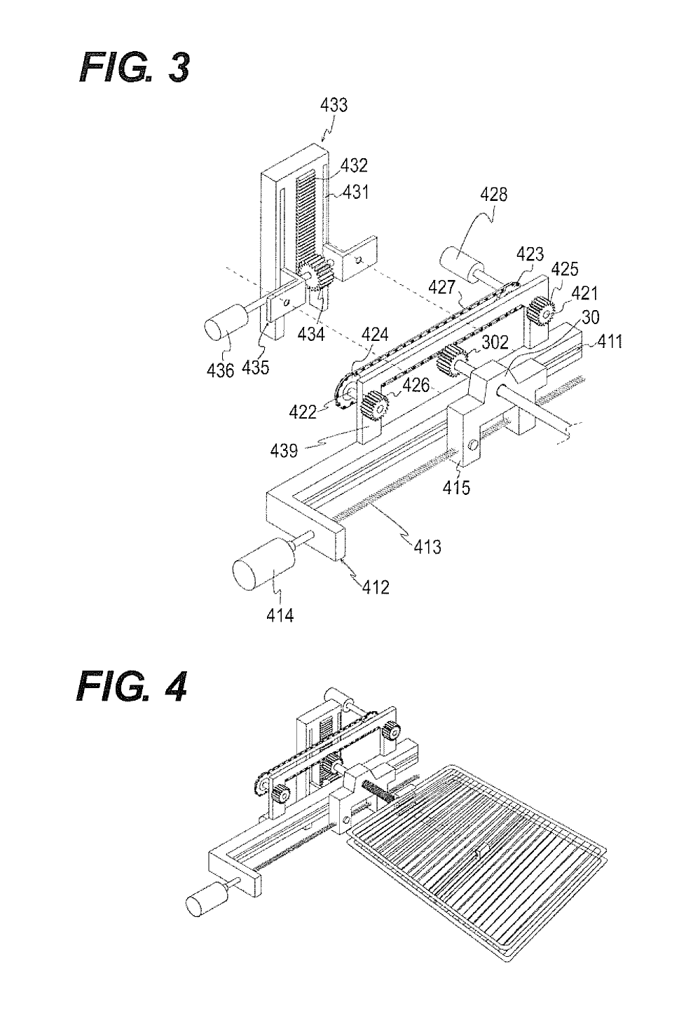

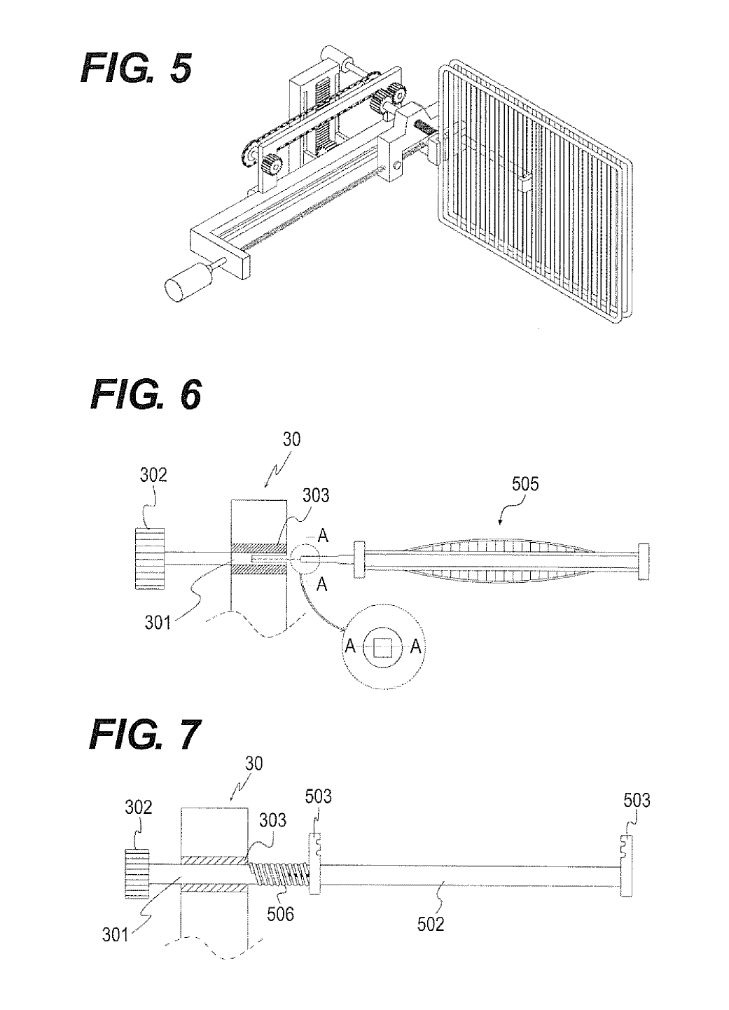

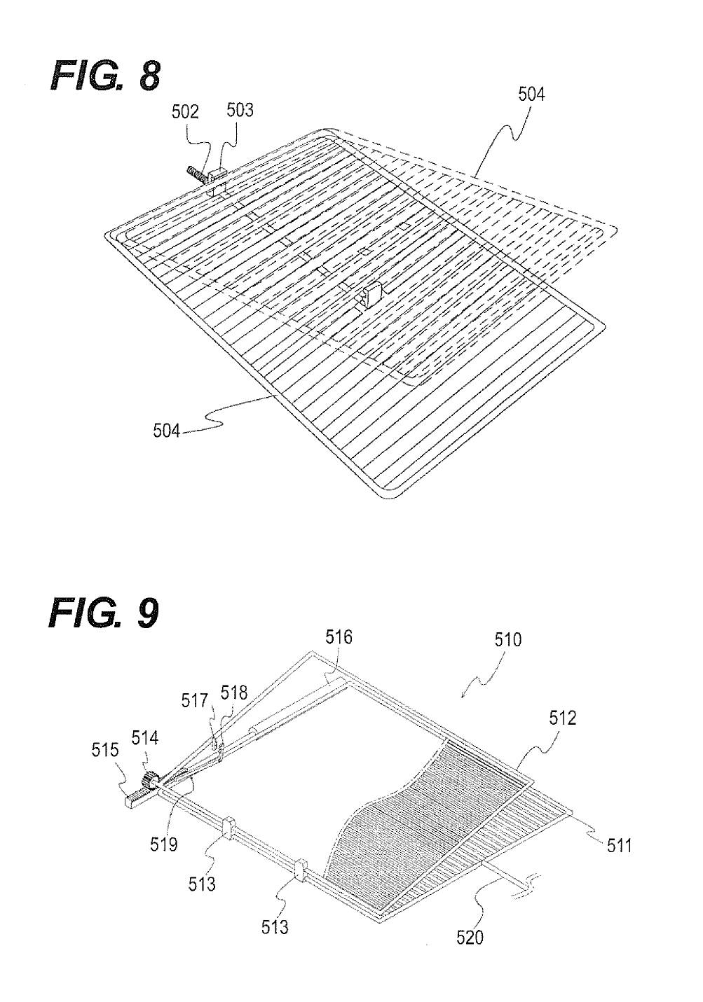

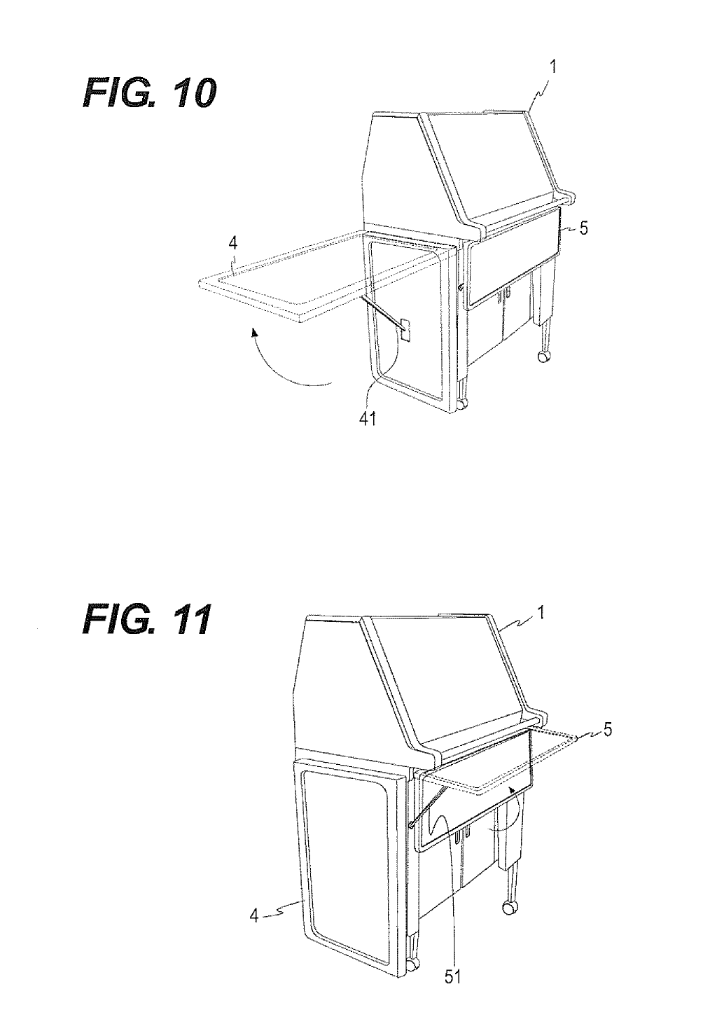

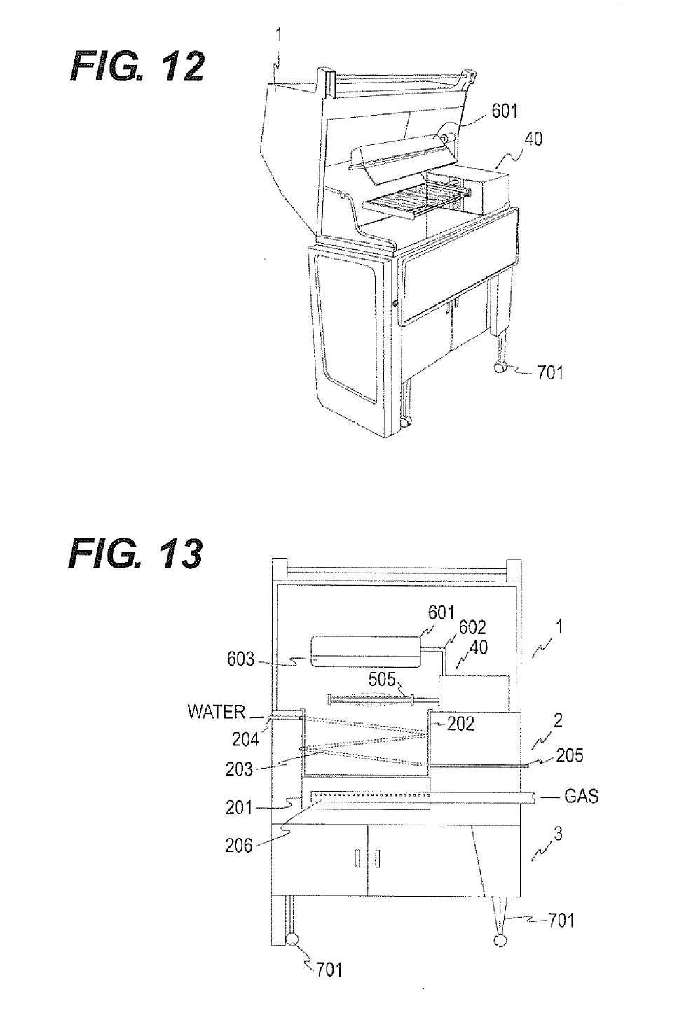

FIG. 1 is a schematic perspective view of a mobile meat roaster according to a first embodiment of the present invention, FIG. 2 is a schematic front sectional view of FIG. 1, FIG. 3 is a schematic exploded perspective view of a first grill operation unit, FIG. 4 is a perspective view illustrating how a double grill is mounted on the first grill operation unit of FIG. 3, FIG. 5 is a perspective view illustrating how the first grill operation unit of FIG. 4 is rotated, FIG. 6 is a schematic sectional view illustrating how the grill is detachably connected to a linear moving part, FIG. 7 is a schematic sectional view illustrating how the double grill is coupled to the linear moving part, FIG. 8 is a perspective view illustrating how the double grill is coupled to grill couplers, FIG. 9 is a perspective view illustrating the shape of an automatic opening type grill, FIG. 10 is a perspective view illustrating how a table shelf operates, FIG. 11 is a perspective view of how the cooking shelf operates, FIG. 12 is a perspective view illustrating how a convex grill is mounted on the device shown in FIG. 1, FIG. 13 is a schematic front sectional view of FIG. 12.

With reference to FIGS. 1 to 13, a mobile meat roaster 1000 according to a first embodiment of the present invention includes a casing, a heat supply part 2 and a first grill operation unit 40.

The casing is of a form of a general box, and it is preferable that it is formed in a two-level structure of the heat supply part 2 for providing heat to the grilled food and a storage layer 3 for storing foods and various tools.

Also, it is possible to install a shelf for storing foods and various tools in the storage layer 3.

In addition, it is preferable to make the inside of the casing wall with a heat insulating material that can prevent heat passing therethrough and is resilient to high temperatures, and make the outside with stainless steel, which is a commonly used material.

The heat supply part 2 is arranged in the casing and plays a role of providing heat to the grilled food.

For this purpose, the heat supply part 2 includes a heat supply housing 201, a heat exchange jacket 203, a gas burner 206, and a charcoal storage housing 202.

The heat supply housing 201 having a rectangular shape is positioned in the casing.

The heat exchange jacket 203 is arranged around the heat supply housing, and a heat-exchange medium passes through therein for absorbing the circumferential heat.

As a heat-exchange medium, water can be used; it is introduced into a water inlet 204, and is discharged from a water outlet 205 through the heat exchange jacket 203.

As mentioned above, the hot water supplied through the heat exchange jacket 203 can be used for cooking and heating.

The gas burner 206 is positioned at the bottom of the heat supply housing 201 to also play a role of igniting the charcoal put in the charcoal storage housing 202.

Also, the gas burner 206 burns the charcoal put in the charcoal storage housing 202 and can control the intensity of a charcoal fire.

The charcoal storage housing 202 can be detachably mounted in the heat supply housing 201, and it is a space where charcoal is stored or burned.

The first grill operation unit 40 which is mounted above the heat supply part 2 moves the grill in the vertical and horizontal directions and rotates it, and includes a grill fixing part 30 for one end portion of the grill to be detachably connected thereto, a horizontal moving unit for moving the grill in the horizontal direction, a rotating unit for rotating the grill, and a lifting unit for lifting and lowing the grill.

The horizontal moving unit includes a main body 412 mounted on the casing, a feed screw 413 and a linear moving part 415, as shown in FIG. 3.

The main body 412 is provided with a first guide rail 411 for guiding the linear movement of the linear moving part and is installed in the width direction of the casing.

The feed screw 413 is rotatably mounted on the main body 412, and a first driving motor 414 is connected to one end thereof.

The feed screw 413 one end of which is mounted on the main body 412 is rotated by the driving force transmitted from the first driving motor 414. The linear moving part 415 is moved in the horizontal direction by the rotation of the feed screw.

The linear moving part 415 is mounted on the feed screw 413, and one side thereof is slidably mounted on the first guide rail 411, and a grill fixing part 30 is coupled to the top center portion of the linear moving part.

The rotating unit includes a first rotating axis 421, a second rotating axis 422, a first sprocket 423, a first rotating gear 425, a second sprocket 424, a second rotating gear 426, a chain 427, and a second driving motor 428.

The first rotating axis 421 and the second rotating axis 422 are mounted on a fixed frame 429 which is fixed to the main body 412 with a predetermined distance along the lengthwise direction of the feed screw.

The first sprocket 423 is installed on one end portion of the first rotating axis 421 to transmit the driving force of the second driving motor 428 via the chain 427 to the second sprocket 424.

The first rotating gear 425 is installed on the other end portion of the first rotating axis 421 to transmit the driving force of the second driving motor 428 to the grill.

The second sprocket 424 installed on one end portion of the second rotating axis 422 is installed in separation on the same line with the first sprocket 423 to transmit the driving force of the second driving motor that is transmitted from the first sprocket 423 via the chain 427 to the grill.

The chain 427 operatively connects the first sprocket and the second sprocket to transmit the driving force of the second driving motor to the grill.

The second driving motor 428 is selectively connected to the first rotating axis 421 or the second rotating axis 422 to provide driving force.

The grill fixing part 30 coupled to the top of the linear moving part 415 includes a spindle 301 and a spindle gear 302.

It is preferable that the spindle 301 is rotatably installed in the grill fixing part 30 through a bearing 303 which is fixed on the outer circumference of the spindle. One end of the grill is inserted in one end of the spindle 301, which is rotatably installed in the grill fixing part 30 through the bearing, during the rotation of the grill.

The spindle gear 302 installed on one end portion of the spindle 301 is selectively engaged with the first rotating gear 425 or the second rotating gear 426 as the linear moving part 415 moves. Accordingly, the spindle gear 302 can transmit the driving force of the second driving motor to the grill by engaging with the first rotating gear 425 or the second rotating gear 426.

To the spindle 301 is coupled one end portion of the grill.

The grill is characterized by including any one of a bar-type single grill 501, a double grill 504, a convex grill 505 or an automatic opening type grill 510.

One end portion of the single grill 501 or convex grill 505 is connected detachably to the spindle 301. At this time, the cross section of one end portion of the single grill 501 or convex grill 505 has a rectangular shape.

The single grill 501 is used for cooking by moving the grill in the vertical direction or in the horizontal direction only without rotating it.

The convex grill 505 is used for cooking fish, for example, and cooking by rotation only.

By dint of the structure that can be rotated with various grills coupled to the spindle 301, it is possible to use in various kinds of roasting just by exchanging the grill in one meat roaster.

As shown in FIG. 8, the double grill 504 further includes a fixed member 502 connected as one to one end of the spindle 301, grill couplers 503 which are coupled to both ends of the fixed member 502 to catch the double grill 504, and an elastic means that provides elastic force between the grill fixing part 30 and one of the grill couplers 503.

It is preferable that an elastic spring 506 is used as the elastic means.

It is preferable that the fixing member 502 further includes rotation preventing slots for preventing rotation when the grill coupler 503 is moved.

The grill couplers 503 have an upper slot and lower slot for the double grill 504 to insert into.

Hereinafter, the coupling method of the double grill 504 is described.

As shown in FIG. 8, first insert one end portion of the double grill 504 into the lower slot of the grill coupler 503 of one side, and gently push the double grill 504 into the lower slot of the grill coupler 503 of the other side, then the double grill 504 has the coupled state maintained by the elastic force of the elastic spring 506 in the lower portion of the grill coupler. Next, also insert the double grill 504 in the upper slot of the grill coupler in the same manner.

Since the double grill 504 contains the food to be grilled between two grills above and below, the food is prevented from falling into the heat supply part 2 when the double grill 504 is rotated.

The automatic opening type grill 510 includes a first grill 511, a second grill 512, a grill-pinion gear 514, a grill-rack gear 515 and an actuating cylinder 516.

The first grill 511 and the second grill 512 have one side pivotally connected so as to be folded and unfolded.

And, the shapes of the first grill 511 and the second grill 512 can be designed in such a way that a predetermined space is provided according to the shape of the food inserted therebetween.

Also, it is preferable that the first grill 511 and the second grill 512 are pivotally connected by hinges 513 with a predetermined interval between them as shown in FIG. 9.

At one side of the second grill is installed an engaging member 517.

On one side of the first grill is rotatably installed a hook 518 that is detachably engaged with the engaging member 517. On the hook 518 is installed a rotary spring (not shown) that adds rotary force in one direction.

On the other side of the first grill 511 is fixed a rotary shaft 520.

The rotary shaft 520 has one end portion connected to the first grill 511 and the other end portion connected as one to the spindle 301.

The hook 518 is engaged with the engaging member 517 by the elastic force of the rotary spring (not shown) to prevent the opening of the first grill 511 and the second grill 512 during the rotation of the automatic opening type grill 510.

The grill-pinion gear 514 is installed on the elongated portion of the coupled side of the second grill to be rotated by the forward and backward movement of the grill-rack gear 515. Accordingly, the second grill 512 is pivoted at a predetermined angle by the grill-pinion gear and the grill-rack gear.

The grill-rack gear 515 is attached to the coupled side of the first grill to mesh with the grill-pinion gear 514, and is moved in a longitudinal direction by the actuating cylinder 516 to rotate the second grill 512.

The actuating cylinder 516 is attached to one side of the first grill 511 to move the grill-rack gear 515 in the longitudinal direction.

At one end portion of the rack gear 515 is further installed a hook release pin 519 to separate the hook 518 from the engaging member 517 as the grill-rack gear 515 is moved in the longitudinal direction.

Hereinafter, the operation method of the automatic opening type grill 510 is described.

As shown in FIG. 9, first when the automatic opening type grill 510 is opened, the grill-rack gear 515 is moved backward by the actuating cylinder 516. At this time, the hook release pin 519 is also moved backward to rotate the hook 518 in the opening direction to separate the hook 518 from the engaging member 517. Next, when the grill-rack gear 515 is moved forward by the actuating cylinder, the grill-pinion gear 514 is rotated to eventually rotate the second grill 512 to open the automatic opening type grill 510.

To shut the automatic opening type grill 510, it is the reverse order of the opening. In this case, the hook 518 is tightly engaged with the engaging member 517 by the elastic force of the rotary spring (not shown).

If the automatic opening type grill 510 is used, the work of holding the grill to open or shut it when roasting meat becomes unnecessary, so worker's roasting work becomes easy and burns of worker can be prevented and the number of workers can be reduced.

The lifting unit includes a guide board 433, lifting sliders 435 and a third driving motor 436.

The guide board 433 has second guide rails 431 for guiding the movement of the lifting sliders 435 and a rack gear 432, and it is vertically fixed to the main body of the meat roaster.

The lifting sliders 435 that are coupled to the main body 412 are slid up and down while being guided by the second guide rails 431, and have a pinion gear 434 meshed with the rack gear 432.

It is preferable that the lifting sliders 435 are coupled to the main body 412 of the horizontal moving unit when it is assembled.

The third driving motor 436 is connected to the pinion gear 434, so the drive force of the motor is transmitted to the pinion gear 434.

The first grill operating unit 40 can be driven manually as well.

In the operating principle of the first grill operating unit 40, the grill is operated by a combined operation of any one or more of the horizontal moving unit, the rotating unit and the lifting unit.

When the feed screw 413 mounted on the main body 412 is rotated by the first driving motor 414, the horizontal moving unit is moved in the horizontal direction as the linear moving part 415 is guided along the first guide rail 411 by the relative rotation of the female thread formed on the linear moving part 415 and the male thread formed on the feed screw 413. Thus, the grill is moved in the horizontal direction.

The rotating unit rotates the grill as shown in FIG. 5.

The operation of the rotating unit is described below. First, the linear moving part 415 is moved by the horizontal moving unit. Then, by the movement of the linear moving part 415, the spindle gear 302 installed on the spindle of the linear moving part 415 is meshed with the first rotary gear 425 or the second rotary gear 426. If the spindle gear is meshed to the first rotary gear 425, which is connected to the motor shaft of the second drive motor 428, the drive force of the motor is transmitted to the spindle gear 302 to rotate the grill.

If the spindle gear is meshed to the second rotary gear, the driving force of the second driving motor 428 is transmitted to the second rotary gear 426 through the first sprocket 423, the chain 427 and the second sprocket 424, so the drive force of the motor is transmitted to the spindle gear 302 to rotate the grill.

Namely, if the linear moving part is advanced by the horizontal moving unit so that the spindle gear 302 is meshed with the first rotary gear 425, the grill rotates in front of the casing; if the spindle gear 302 is meshed with the second rotary gear 426, the grill rotates above the heat supply part 2.

In the lifting unit, if the pinion gear 434 connected to the lifting sliders 435 is rotated by the third driving motor, the lifting sliders 435 are moved up and down by the interaction of the pinion gear 434 and the rack gear 432 formed on the guide board 433. As a result, the main body fixed on the lifting sliders of the lifting unit is moved up and down to move the grill up and down.

Since the grill can be moved in the horizontal direction, it is possible to check accurately the roasted condition of the food by moving the grill forward. Also, it is possible to prevent the worker from inhaling gases and burning due to heat, and improve work convenience.

If the grill rotates, heat can be transmitted uniformly to the whole of the food to be grilled, so it is possible to prevent the food from burning and improve the taste of the grilled food.

Also, if charcoal fire is used as the heat source, it is difficult to control the fire intensity, but since it is possible to move the grill up and down, it is possible to adequately control the temperature for roasting the food by moving the grill up and down.

The top of the casing is further provided with a ceramic burner 601 for providing heat downward.

Since the ceramic burner 601 is connected to the first grill operation unit through the control link 602, the upward and downward movement and rotary motion of the ceramic burner 601 are possible. The ceramic burner may further include a radiation plate 603 that is coupled thereto by a hinge.

Since rotary motion of the ceramic burner 601 is possible, sufficient work space is secured for the worker to put meat on the grill.

Height adjustment and rotation are possible for the ceramic burner 601 by the control link 602.

The ceramic burner 601 is placed on the casing to help with complete combustion of gas, and since it provides heat from above and below, it has an effect that foods can be cooked quickly without turning them over. Also, it improves the worker's working environment as gases are completely burned, and has an advantage that it is unnecessary to install hoods and ducts because smoke and smell are not generated during roasting work.

The radiation plate 603 is pivotally connected to the ceramic burner 601 to make upward and downward adjustment possible and plays a role of reflecting the radiation heat.

A heat exchange jacket may be formed in the ceramic burner 601, and the recovered heat of the ceramic burner 601 may be used to heat water in the jacket to be used as hot water.

The mobile meat roaster 1000 is portable and may be fixed in a place to be used.

The upper portion of the casing further includes a cover 1. By using the cover 1, rainwater is prevented from flowing into the casing in rainy days, and various impurities are prevented from staining it during storage. Also, the grill, etc. can be prevented from damage during transit.

The casing further includes a movement means at the bottom portion thereof.

The movement means employs a plurality of wheels 701. The mobile meat roaster can be moved more easily by the movement means.

The casing further includes a table shelf 4, one end portion of which is pivotally connected and which can be folded and unfolded manually.

As shown in FIG. 10, the table shelf 4 can be folded and unfolded, and a table self-rack gear 41 is pivotally connected under side thereof. The table self-rack gear 41 for the table shelf is meshed with a table shelf pinion gear (not shown) installed inside the casing.

The table shelf 4 can be operated manually or automatically.

The table shelf 4 has a rectangular cross section and is used as a table at which four to five people can gather to take a meal outdoors.

The casing further includes a cooking shelf 5, one end portion of which is pivotally connected and which can be folded and unfolded manually.

As shown in FIG. 11, the cooking shelf 5 can be folded and unfolded, and a cooking shelf-rack gear 51 is pivotally connected in the bottom end portion of the cooking shelf 5. The cooking shelf-rack gear 51 is meshed with a cooking shelf pinion gear (not shown) installed inside the casing.

The cooking shelf 5 can be operated manually or automatically.

The table shelf 4 has a rectangular cross section, and it is preferable that it is at waist height. On the table shelf 4 can be put foods to be cooked such as meat to make it convenient to roast a large quantity of meat continuously.

A second embodiment of the present invention will be described below with reference to the attached drawings. The same reference symbols will be used for a construction identical or equivalent to the first embodiment mentioned above and duplicated descriptions for this will be omitted.

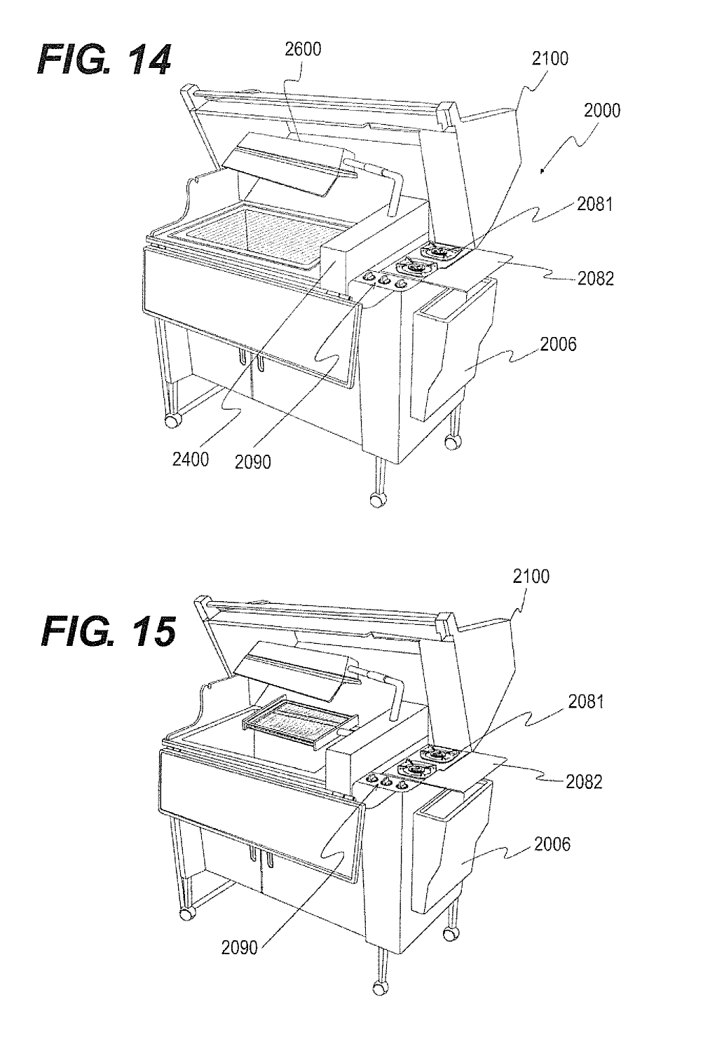

FIG. 14 is a perspective view of a mobile meat roaster equipped with the gas burner of the second embodiment of the present invention, and FIG. 15 is a perspective view illustrating how a convex grill is mounted in FIG. 14.

The mobile meat roaster 2000 of the present embodiment further includes a storage box 2006 compared with the first embodiment.

The casing further includes a storage box 2006 at side thereof that can store cooking tools. It is possible to keep scissors, tongs, knives, etc. in the storage box 2006 to be used for cooking.

If the storage box 2006 is further included, it is possible to improve overall convenience and cooking speed during cooking.

The casing further includes a gas range 2081 at one side thereof.

The gas range 2081 can further include a sliding door cover 2082 on the top thereof.

It is preferable to install the gas range 2081 adjacent to a second grill operation unit 2400. It is possible to install a two burner type gas range 2081.

The gas range 2081 can be used for cooking other foods such as soup besides the food to be roasted. Therefore, it has an effect of shortening the cooking time when cooking many foods simultaneously.

The casing further includes a controller 2090 at one side thereof for controlling the gas burner 2600 and the second grill operation unit 2400. The casing includes a cover 2100 which can cover the top of the casing.

The controller 2090 includes an automatic operation button, which enables the gas burner 2600 to automatically move in the horizontal and vertical directions, as well as rotate, and a fire intensity control switch, which can control the fire intensity of the gas range 2081 step by step.

If the roast is automatically cooked by the controller 2090, the user can secure time for doing other works.

If charcoal is used as fuel for the mobile meat roaster 2000, the fire intensity control switch allows the gas burner 2600 to function as a controller of charcoal fire intensity.

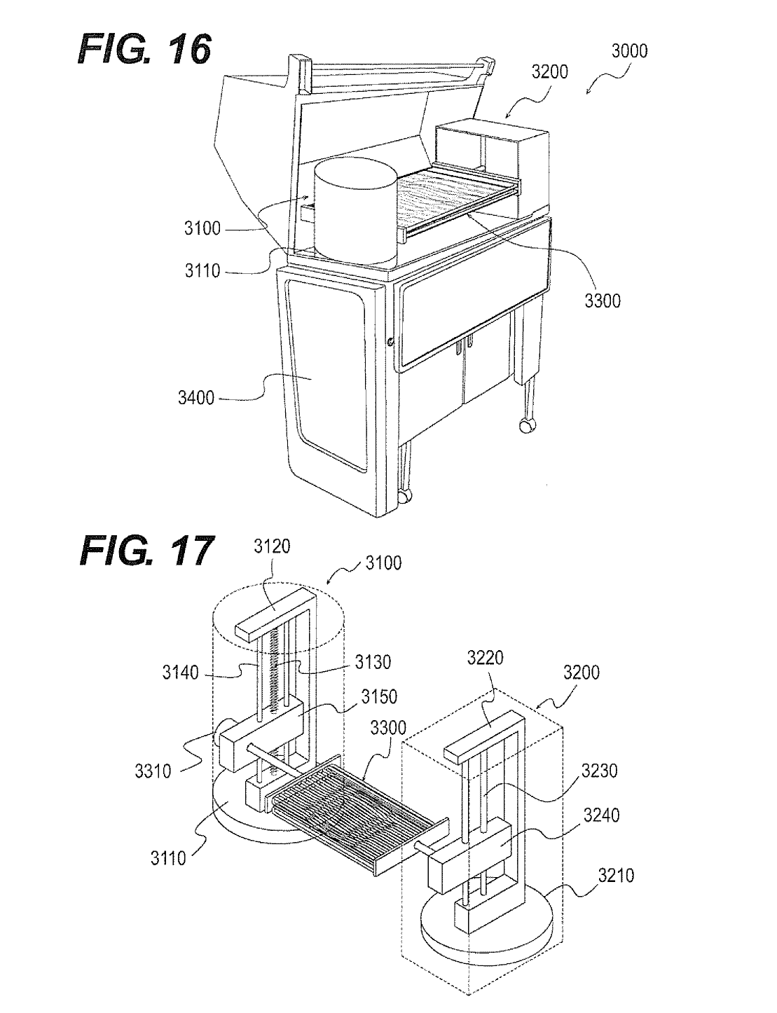

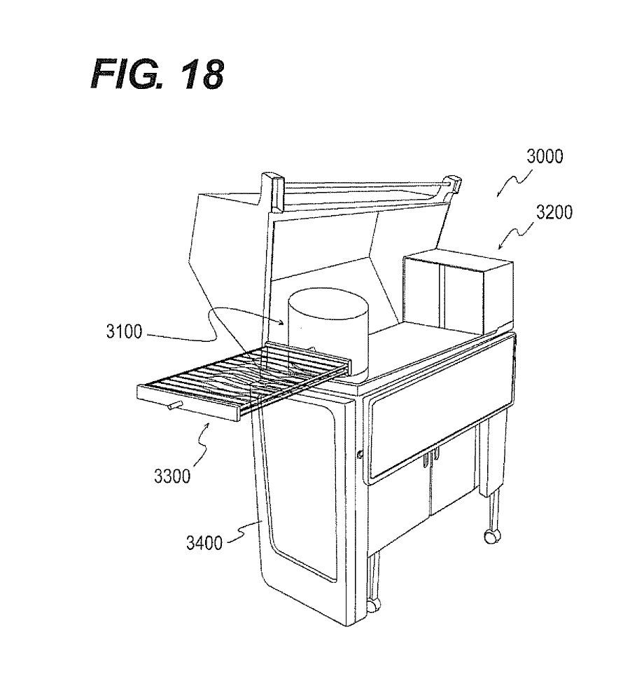

With reference to the attached drawings, a third embodiment of the present invention is described below. FIG. 16 is a schematic perspective view of a mobile meat roaster according to the third embodiment of the present invention, FIG. 17 is a block diagram illustrating the grill operator unit and grill fixing part of FIG. 16, and FIG. 18 is a perspective view illustrating how the device shown in FIG. 16 operates.

With reference to FIGS. 16 to 18, the mobile meat roaster 3000 according to the present embodiment includes a casing, a heat supply part, a convex grill 3300, a grill operator 3100, and a second grill fixing part 3200.

The convex grill 3300 is a place where foods are cooked above the heat supply part.

The convex grill 3300 is a grill made of two upper and lower layers with the central portion formed convexly. The convex grill 3300 is used for cooking foods of a large volume such as fish.

Also, variations of the convex grill 3300 can be used to suit different foods such as meat or vegetables.

Also, the convex grill 3300 has two grills pivotally connected so as to be folded and unfolded. It is preferable that the free end of either grill is provided with a fastener (not shown) to enwrap and fix the other grill.

The grill operator 3100 includes a rotating part and a lifting part.

The grill operator 3100 is mounted above the heat supply part, and one end portion thereof is connected to the convex grill 3300. The grill operator moves upward and downward and rotates the convex grill 3300 during cooking.

The rotating part rotates the lifting part to left and right.

The rotating part consists of a first rotating plate 3110 and a motor (not shown) that rotates the rotating plate.

The first rotating plate 3110 is rotated by the motor (not shown) to rotate the lifting part.

The lifting part includes a first frame 3120 and a slider 3150.

The first frame 3120 is fixed on the rotating plate 3110 to be installed thereon.

Also, the first frame 3120 includes a second speed screw 3130 and first guide bars 3140.

The second feed screw 3130 is installed across both end portions of the first frame 3120, and a shaft of a motor (not shown) is connected to one end portion of the second feed screw 3130.

The first guide bars 3140 are fixed across both end portions of the first frame 3120.

The second speed screw 3130 and the first guide bar 3140 are installed through the slider 3150. The slider is lifted or lowered by the rotation of the second speed screw 3130 along the first guide bars 3140.

The convex grill 3300 is rotatably installed to the slider 3150.

One end of the convex grill 3300 passes through the slider 3150 to be connected to the motor shaft of a fourth driving motor 3310.

Also, it is preferable that one end of the convex grill 3300 is mounted in the slider 3150 through a bearing (not shown) or a spindle (not shown). When the convex grill 3300 is rotated by the fourth driving motor 3310, direct frictional contact with the slider 3150 is prevented through the bearing or spindle.

The second grill fixing part 3200 is mounted on the other side of the grill operator 3100, and the other end portion of the convex grill 3300 is detachably connected to this unit.

The second grill fixing part 3200 includes a second rotating plate 3210, a second frame 3220, and a second slider 3240.

The second rotating plate 3210 is rotatably mounted on the heat supply part.

The second frame 3220 is vertically installed on the second rotating plate 3210 and has second guide bars 3230 fixed across both end portions of the frame for guiding the second slider 3240.

The second slider 3240 is lifted or lowered along the second guide bars 3230 and has a joining hole (not shown) formed on one side for the other end portion of the convex grill 3300 to be coupled thereto.

The second grill fixing part 3200 can be rotated manually. It is preferable that the joining hole is formed in a conical shape with a wide inlet so that joining becomes easy when the second grill fixing part 3200 is rotated manually to be coupled to the other end portion of the convex grill 3300.

Below will be described the operation of the present embodiment.

When a large-volume food to be grilled is fixed on the convex grill 3300, the fourth driving motor 3310 is operated to rotate the grill. At this time, the other end portion of the convex grill 3300 is rotated while it is put into the joining hole of the second slider 3240. The food is cooked uniformly on the whole by the rotation of the convex grill 3300.

When the first slider 3150 is moved up and down by the rotation of the second feed screw 3130, the convex grill 3300 is also moved up and down. Accordingly, it is possible to control the cooking temperature by adjusting the distance to charcoal fire.

The first slider 3150 can have its height adjusted manually or automatically by a height detecting sensor. At this time, the other end portion of the convex grill 3300 is slid along the second guide bar 3230 while it is coupled to the second slider 3240.

When cooking the food is completed, first the second grill fixing part 3200 is rotated to detach the second slider 3240 from the convex grill 3300. Then, as shown in FIG. 18, the first rotating plate 3110 is rotated to place the convex grill 3300 outside the casing.

According to the present embodiment, the grilled food can be placed on the table shelf 3400 without the user himself carrying the heated convex grill 3300. Therefore, the user is prevented from injury by heat.

Also, if the table shelf 3400 is unfolded for use, the convex grill 3300 is placed above the table shelf 3400 with a separation of a predetermined distance. Therefore, the users can eat the grilled foods right from the convex grill 3300, and since space between the convex grill 3300 and the table shelf 3400 is provided for other side dishes to be put on, it is easy to utilize space.

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

What is claimed is:

1. A mobile meat roaster comprising:
a casing which forms the main body of the meat roaster;
a heat supply part arranged in the casing for providing heat to the food to be grilled; and
a first grill operation unit mounted at the upper portion of the heat supply part for rotating a grill as well as moving it in a vertical direction and a horizontal direction during cooking, wherein the first grill operation unit includes a grill fixing part to which one end portion of the grill is detachably connected, a horizontal moving unit for moving the grill in the horizontal direction, a rotating unit for rotating the grill, and a lifting unit for moving the grill in the vertical direction.

2. The device according to claim 1, wherein the horizontal moving unit includes:
a main body including a first guide rail;
a feed screw which is mounted on the main body and is operatively connected to a first driving motor at one end; and
a linear moving part which is mounted on the feed screw, and one side of which is slidably installed on the first guide rail, wherein the grill fixing part is coupled to the linear moving part.

3. The device according to claim 2, wherein the rotating unit includes:
a first rotating axis and a second rotating axis which are installed on a fixed frame mounted on the main body of the horizontal moving unit with a predetermined distance;
a first sprocket installed on one end portion of the first rotating axis;
a first rotary gear installed on the other end portion of the first rotating axis to transmit driving force;
a second sprocket installed on one end portion of the second rotating axis;
a second rotary gear installed on the other end portion of the second rotating axis to transmit driving force;
a chain which operatively connects the first sprocket and the second sprocket to transmit driving force therebetween; and
a second driving motor which is connected to the first rotating axis or the second rotating axis to provide driving force thereto, and
wherein the grill fixing part includes:
a spindle mounted at the upper portion of the linear moving part to fix the grill, and a spindle gear installed on one end portion of the spindle to be selectively engaged with the first rotary gear or second rotary gear according to the movement of the linear moving part.

4. The device according to claim 2, wherein the lifting unit includes:
a guide board which has second guide rails and a rack gear, and is vertically mounted to the main body of the meat roaster;
lifting sliders which are slid up and down along the second guide rails, and have a pinion gear meshed with the rack gear of the guide board, and are coupled to the main body of the horizontal moving unit; and
a third driving motor which is connected to the pinion gear to provide driving force thereto.

5. The device according to claim 4, wherein the heat supply part includes:
a heat supply housing positioned in the casing;
a heat exchange jacket arranged around the heat supply housing to absorb circumferential heat;
a gas burner mounted on the floor of the heat supply housing for providing heat; and
a charcoal storage housing detachably mounted in the heat supply housing to store charcoal.

6. The device according to claim 5, wherein the casing further includes a ceramic burner for providing heat from above to below.

7. The device according to claim 1, wherein the casing further includes a cover arranged at the upper portion thereof.

8. The device according to claim 1, wherein the casing further includes a movement means rotatably installed at the bottom portion thereof.

9. The device according to claim 1, wherein the casing further includes a table shelf pivotally connected to one side thereof so as to be folded and unfolded manually.

10. The device according to claim 1, wherein the casing further includes a cooking shelf pivotally connected to one side thereof so as to be folded and unfolded manually.

11. The device according to claim 6, wherein the grill is any one of a single grill, a double grill, a convex grill or an automatic opening type grill.

12. The device according to claim 11, wherein the single grill or convex grill has one end portion fixed to the spindle and the sectional shape of the one end portion is rectangular.

13. The device according to claim 11, wherein the double grill includes a fixed member which has one end portion fixed as one to the spindle, grill couplers installed at both end portions of the fixed member to fix the double grill, and an elastic means installed between the grill fixing part and the grill coupler to provide elastic force thereto.

14. The device according to claim 11, wherein the automatic opening type grill includes:
a first grill and a second grill which are pivotally connected at one side to each other by hinges so as to be folded;
a grill-pinion gear which is installed at the coupled side of the second grill to transmit rotary force thereto;
a grill-rack gear which is attached to the coupled side of the first grill to mesh with the grill-pinion gear for rotating the second grill by moving in a longitudinal direction;
a actuating cylinder which is attached on one side of the first grill to move the grill-rack gear in the longitudinal direction;
an engaging member fixed on one side of the second grill;
a hook rotatably installed on one side of the first grill to be detachably connected to the engaging member, wherein the hook has a rotary spring to add rotary force in one direction;
a hook release pin installed on one end portion of the grill-rack gear to separate the engaging member as the grill-rack gear is moved in the longitudinal direction; and
a rotary shaft, one end portion of which is fixed to the first grill and the other end portion of which is fixed as one to the spindle.

15. The device according to claim 10, wherein the casing further includes a storage box attached at one side thereof to store cooking tools.

16. The device according to claim 15, wherein the casing further includes a gas burner positioned adjacent to a second grill operation unit at one side thereof.

17. The device according to claim 16, wherein the casing further includes a gas range and a controller for controlling the operation of the gas range and the second grill operation unit.

18. A mobile meat roaster comprising:
a casing which forms the main body of the meat roaster;
a heat supply part arranged in the casing for providing heat to the food to be grilled;
a convex grill in which the food to be grilled is contained, wherein the food to be grilled is grilled above the heat supply part;
a grill operator mounted at the upper portion of the heat supply part for rotating a grill as well as moving it in a vertical direction during cooking, wherein one end portion of the convex grill is connected to the grill operator;
a second grill fixing part mounted at the other side of the grill operator, and to which the other end portion of the convex grill is detachably connected, and
wherein the grill operator includes: a rotating part for rotating the grill operator to left and right; and a lifting part having a first frame which is fixed on the rotating part and has a second feed screw rotated by a motor and first guide bars fixed across both end portions of the first frame, and a slider through which the second feed screw and the first guide bars are installed to be lifted and lowered by the rotation of the second feed screw, and to which one end portion of the convex grill is rotatably connected, and
wherein the second grill fixing part includes: a second rotating plate rotatably mounted on the heat supply part; a second frame which is fixed on the second rotating plate and has second guide bars; and a second slider through which the second guide bars are installed to be lifted or lowered along the second guide bars, and to which the other end portion of the convex grill is detachably connected.
